(19) United States
(12) Patent Application Publication
(10) Pub. No.: US 2025/0245362 A1
(43) Pub. Date: Jul. 31, 2025

(54) DATA WRITING PROTECTION

(71) Applicant: STMicroelectronics International N.V., Geneva (CH)

(72) Inventors: Marc LACRUCHE, Fuveau (FR); William ORLANDO, PEYNIER (FR)

(21) Appl. No.: 19/020,415

(22) Filed: Jan. 14, 2025

(30) Foreign Application Priority Data
Jan. 26, 2024 (FR) FR2400758

(51) Int. Cl. G06F 21/62; G06F 21/55

(52) U.S. Cl. CPC G06F 21/6209; G06F 21/554; G06F 2221/034

(57) ABSTRACT

A device and method for protecting a writing of data is provided. An example device and method includes protecting a writing of data into at least one register of at least a first electronic circuit. The device is adapted to storing a first verification table comprising for each of the at least one register: at least one first piece of information concerning the writing of data into the at least one register; and at least a second piece of information indicating whether or not a data item has been written into the at least one register.

### CROSS REFERENCE TO RELATED APPLICATIONS

This application claims the priority benefit of French patent application number FR2400758, filed on Jan. 26, 2024, entitled “Protection de l'écriture de données”, which is hereby incorporated by reference to the maximum extent allowable by law.

### TECHNICAL FIELD

The present disclosure generally concerns the protection of electronic systems and devices, and, in particular, the protection of the implementation of such electronic systems and devices. The present disclosure more specifically relates to protection against attacks that may occur during the writing of data into registers.

### BACKGROUND

Complex systems and devices are generally formed of a main control circuit, such as a processor, a microprocessor, a controller, a microcontroller, or any other circuit capable of writing into registers of another circuit for the execution of an operation, which is adapted to controlling one or a plurality of secondary electronic circuits.

When the main circuit controls a secondary circuit, it is common for it to need to write data into accessible registers of the secondary circuit. Such a step may be sensitive to fault injection attacks, during which a third-party device may, for example, modify the data being written. Similarly, such a step may be sensitive to faults that may naturally occur during the operation of the main and secondary circuits.

It would be desirable to be able to improve, at least partly, certain aspects of the protection of the writing of data into registers.

### BRIEF SUMMARY

There exists a need for more secure data write methods.

There is a need for data write methods protected against fault injection attacks.

An embodiment overcomes all or part of the disadvantages of known data write methods.

An embodiment overcomes all or part of the disadvantages of known electronic devices enabling to protect the writing of data.

An embodiment provides an electronic device adapted to verifying the execution of a data write method.

An embodiment provides a method of protection of a data write method.

These two embodiments provide the implementation of different tests and the use of a verification table.

An embodiment provides a device of protection of a writing of data into at least one register of at least one first electronic circuit, the device being adapted to storing a first verification table comprising for each of the at least one register:
at least a first piece of information concerning the writing of data into the at least one register; and
at least a second piece of information indicating whether a data item has been written or not into the at least one register.

Another embodiment provides a method of protection of a writing of data into at least one register of at least one electronic circuit, implemented by a protection device adapted to storing a first verification table comprising for each of the at least one register:
a first piece of information concerning the writing of data into the at least one register; and
a second piece of information indicating whether a data item has been written or not into the at least one register.

According to an embodiment, the first piece of information indicates whether a data writing is required in the at least one register.

According to an embodiment, the first verification table comprises, for each of the at least one register, a third piece of information concerning the writing of data into the at least one register.

According to an embodiment, the third piece of information indicates whether a data writing is authorized in the at least one register.

According to an embodiment, the first verification table comprises, for each of the at least one register, a fourth piece of information concerning the writing of data into the at least one register.

According to an embodiment, the fourth piece of information indicates:
whether the value of the data item to be written is authorized or not;
whether the data item to be written has priority or not; or
whether the data item to be written is temporary or permanent.

According to an embodiment, the first verification table is adapted to being used during a data writing comprised in the implementation of a first instruction by a processor.

According to an embodiment, the device further comprises a second verification table.

According to an embodiment, the second verification table is adapted to being used during a data writing comprised in the implementation of a second instruction by the processor, different from the first instruction.

According to an embodiment, the device or the method, previously described, further protects a writing of data into at least one register of at least one second electronic circuit, different from the first electronic circuit.

According to an embodiment, the first circuit is adapted to modifying the first verification table.

Another embodiment provides an electronic system comprising the at least one first electronic circuit, and a control circuit.

Another embodiment provides a method of writing data into at least one register of at least the at least one first electronic circuit comprising the implementation of the previously-described protection method.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of an electronic system;

FIG. 2 shows an implementation mode of a method of protection of a data write method executed within the device of FIG. 1; and

FIG. 3 shows tables illustrating the implementation mode of FIG. 2.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

The embodiments described hereafter concern the protection of the writing of data into registers of an electronic device. In complex electronic systems, it is common for a main electronic circuit, such as a processor, to need, for the implementation of instructions, to write data into registers of secondary electronic circuits. A problem that the embodiments aims at solving is to ensure a correct writing of the data into these registers. Indeed, different types of attack may be implemented during such a write operation, such as a fault injection attack, which can result in the unauthorized writing into registers, the lack of writing of data into registers, or also the writing of incorrect data into registers.

The methods described hereafter provide the implementation of a verification table during the write operation, enabling to ensure the correct implementation of this operation, be it to prevent a malicious attack or to verify the robustness of a data write operation. These embodiments more particularly enable to verify that all the data necessary for the implementation of a circuit have been correctly supplied to this circuit.

The embodiments described hereafter can apply to all types of complex electronic systems, such as computers. In particular, these embodiments are preferably applied to the fields of electronic systems on board vehicles, such as motor vehicles, but also the field of industrial communication buses.

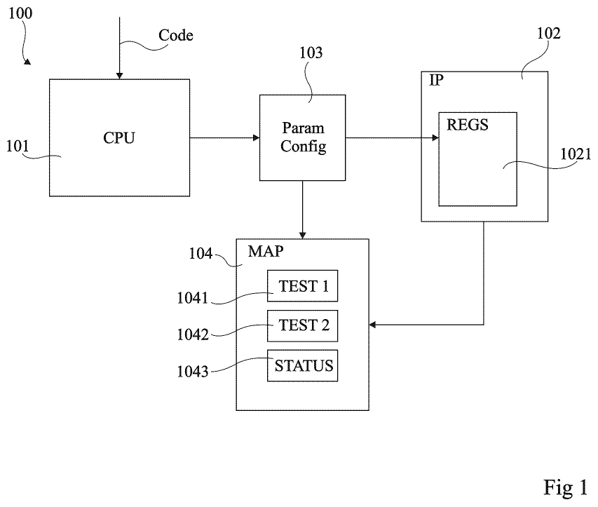

FIG. 1 shows, very schematically and in the form of blocks, an electronic system 100 according to an embodiment.

Electronic system 100 comprises a main control circuit 101 (CPU) and at least one secondary electronic circuit 102 (IP).

Main control circuit 101 is, for example, a processor, a microprocessor, a controller, a microcontroller, etc. According to an embodiment, control circuit 101 is adapted to receiving programming codes Code and to translating them into one or a plurality of instructions to implement secondary electronic circuit 102.

Secondary electronic circuit 102 is a circuit adapted to implementing a specific function, such as a dedicated processor, a measurement circuit, a specific control circuit, etc. Circuit 102 comprises at least one register 1021 (REGS), preferably a plurality of registers 1021, enabling to store data, such as configuration data and/or data enabling to implement the circuit. According to an embodiment, when main circuit 101 executes an instruction concerning secondary circuit 102 it must, generally, update all or part of the data stored in registers 1021.

To perform an operation of writing of data into registers 1021 in protected manner, system 100 further comprises a protection device 103 (Param Config). Device 103 is adapted to protecting a writing of data into the register(s) 1021 of circuit 102. More particularly, device 103 is adapted to verifying whether a data writing, for the implementation of an instruction by main control circuit 101, is carried out correctly.

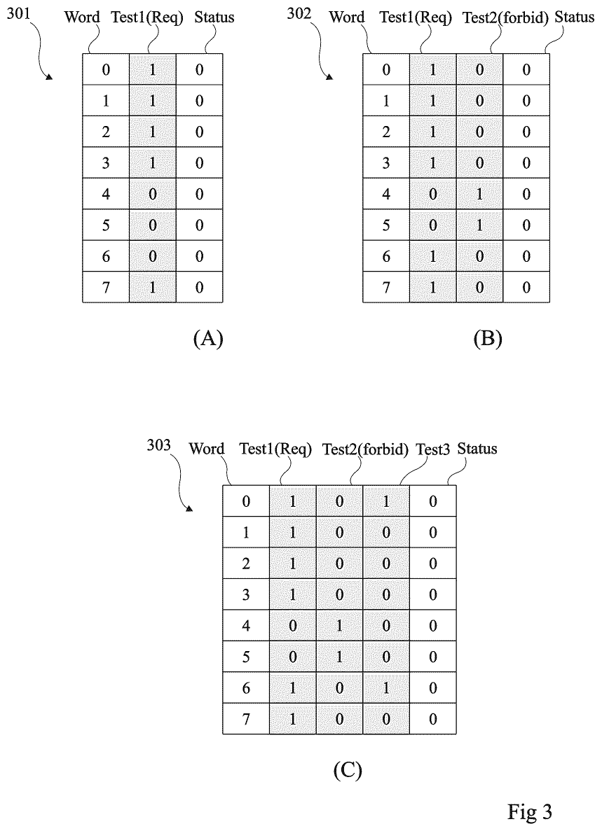

For this purpose, device 103 is adapted to storing one or a plurality of verification tables 104 (MAP). Verification table 104 is used to verification whether the writing of data into registers 1021 is carried out correctly. More particularly, verification table 104 comprises, for each register among registers 1021, at least information 1041 (TEST 1), 1042 (TEST 2) concerning the writing of data into the register, and information 1043 (STATUS) indicating whether a data item has been written the register. According to an example, information 1041 and 1042 may indicate whether or not it is authorized to write into a register, whether or not it is required to write into a register. According to another example, information 1041 and 1042 may be used to test the data item to be written into a register, or to define an order of priority for the writing into the registers. Detailed examples of verification tables are described in relation with FIG. 3. According to an example, circuit 102 is adapted to updating verification table(s) 104, for example after the execution of a first operation.

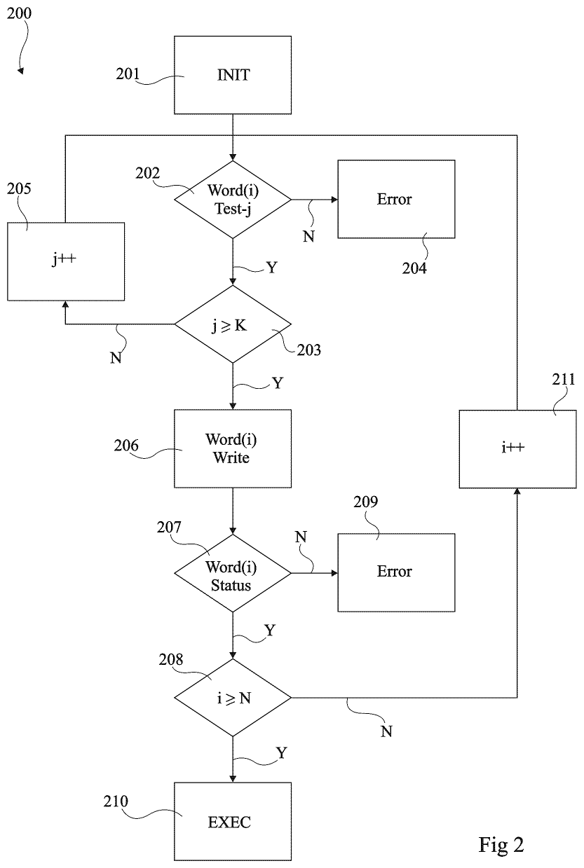

An implementation mode of device 103, and of the associated protection method, is described in relation with FIG. 2.

According to an embodiment, device 103 may comprise a plurality of verification tables 104 associated with the writing of data into secondary circuit 102, each verification table 104 being associated with a specific instruction implemented by main control circuit 101 and by secondary circuit 102. Indeed, data 1041 and 1042 may be different according to the type of instruction implemented by main control circuit 101.

In addition, system 100 may comprise a plurality of secondary electronic circuits 102 of the type of circuit 102. It is possible, in this case, for device 103 to protect the writing of data into the register(s) of a plurality of different secondary circuits 102. To achieve this, device 103 may, for example, use the same verification table 104 for a plurality of different secondary circuits 102, or comprise a plurality of verification tables 104, each associated with one or a plurality of different secondary circuits 102.

According to a first embodiment, device 103 is a device independent from main control circuit 101 and from secondary circuit 102. According to a second embodiment, device 103 forms part of main control circuit 101. According to a third embodiment, device 103 forms part of secondary circuit 102.

FIG. 2 is a block diagram illustrating a method 200 of protection of the writing of data into registers of electronic circuits implemented, within the system 100 described in relation with FIG. 1, by device 103.

It here is considered that electronic circuit 102 comprises N registers Reg(i), N being an integer greater than or equal to one, and i being an integer in the range from 1 to N, into which main control circuit 101 wishes to write N data words Word(i).

Further, it is considered that verification table 104 comprises, for each register, K pieces of information Test-j relative to the writing of data into a register Reg(i), K being an integer greater than or equal to one, and j being an integer in the range from 1 to K. In other words, the writing of a data Word(i) into a register Reg(i) is performed if the K piece of information are verified.

At an initial step 201 (INIT), control circuit 101 has received a programming code Code, and wishes to implement an instruction by writing data Word(i) into the registers Reg(i) of circuit 102. In verification table 104, all the pieces of information indicating whether a data item has been written into registers Reg(i) have been reset to indicate that no data item has been written into registers Reg(i). According to an example, by convention, if the piece of information indicating whether data item has been written into a register Reg(i) is binary data item, then its value is set to zero.

At a step 202 (Word(i) Test-j), following step 201, the information Test-j associated with data word Word(i) is verified. If the test is successful (output Y of block 202), the next step is a step 203 (j>=K), otherwise (output N of block 202), the next step is a step 204 (Error).

At step 203, following step 202, the value of integer j is compared with the value of integer K. If integer j is greater than or equal to integer K (output Y of block 203), the next step is a step 206 (Word(i) Write), otherwise (output N of block 203), the next step is a step 205 (j++).

At step 204, following step 202, the information Test-j associated with data word Word(i) is not verified. This may indicate that an error has occurred or that an attack has taken place during the sending of the data to circuit 102. An error message is, for example, sent to main control circuit 101 and/or to secondary circuit 102. According to an example, the error message may be different according to the verified information Test-j. According to a first example, if information Test-j is not verified, the protection method prevents any writing of data into registers Reg(i). According to a second example, if information Test-j is not verified, then the protection method prevents the writing of the concerned data item Word(i) into the register Reg(i) which is associated therewith.

Further, at step 204, according to an example, the value of integer j may be reset, that is, set to one.

In other words, during steps 202 to 205, the pieces of information Test-1 to Test-K associated with data word Word(i) are all verified one by one. If information Test-j is not verified, an error message may be sent.

At step 205, the value of integer j is incremented by one unit, for example by one.

At step 206, following step 203, all the pieces of information Test-1 to Test-K associated with data word Word(i) have been verified. Thus, data word Word(i) may be written into register Reg(i).

At a step 207 (Word(i) Status), following step 206, the information indicating whether a data item has been written into a register Reg(i) is modified to indicate that a data item is written therein. Further, before modifying the value of this information, it is verified whether it did indicate that no data was written in the register. If the test is successful (output Y of block 207), the next step is a step 208 (i>=N), otherwise (output N of block 207), the next step is a step 209 (Error).

At step 208, following step 202, the value of integer i is compared with the value of integer N. If integer i is greater than or equal to integer N (output Y of block 208), the next step is a step 210 (EXEC), otherwise (output N of block 208), the next step is a step 211 (i++).

At step 209, following step 207, the information indicating that a data word has been written into a register has not had its value modified. This may indicate that an error has occurred or that an attack has taken place during the sending of data to circuit 102. An error message is, for example, sent to main control circuit 101 and/or to secondary circuit 102. According to a first example, if this information is not verified, then the protection method prevents any writing of data into registers Reg(i). According to a second example, if this information is not verified, then the protection method prevents the writing of the concerned data word Word(i) into the register Reg(i) which is associated therewith. According to a third example, no error message is sent to avoid providing information to a possible attacker.

Further, at step 209, according to an example, the value of integer i may be reset, that is, reset to one.

At step 211, following step 208, the value of integer i is incremented by one unit, for example by one.

At step 210, following step 208, integer i is greater than or equal to integer N, this indicates that all data words Word(i) have been written into registers Reg(i). The instruction desired to be implemented by main control circuit 101 may continue its implementation.

An advantage of this protection method, and of the protection device 103 implementing it, is that it enables to verify the writing of each data word Word(i) into a register Reg(i).

According to an embodiment, protection method 200 may also form part of a method of writing of data into registers.

Further, in the example of FIG. 2, it is envisaged for the writing of the words to be carried out in the order of the data words. However, as a variant, it may be envisaged for requests to write data words Word(i) and for the writing of data words Word(i) to be carried out in a first order, and for the verification of the statuses of the written data words Word(i) to be carried out in a second order different from the first one.

Similarly, in the example of FIG. 2, it is envisaged for the operation to occur after the verification of the status of the written data words Word(i), but it may also be envisaged for this execution to occur before this verification.

FIG. 3 comprises three views (A), (B), and (C), each illustrating an example 301, 302, and 303 of the verification table 104 described in relation with FIG. 1, and used by the protection method 200 described in relation with FIG. 2.

Each verification table 301 to 303 has a number of rows corresponding to the number of registers of circuit 102. In the example of FIG. 3, each verification table comprises eight lines. In the example of FIG. 2, each verification table comprises N rows.

Each verification table 301 to 303 comprises a first column Word (on the left-hand side in FIG. 3) listing the indices of the data words and of their associated registers. According to a first example, this first column Word is not essential for the implementation of the embodiments, since the index of the data words can be simply verified with the index of the row of the verification table. According to a second example, the first column Word may comprise the indices of the words in an order different from the conventional increasing order, this could enable to define an order for the writing of the data words, or simply to secure the writing of the data words by masking the order of the data words to be written.

Each verification table 301 to 303 includes a last column Status (on the right-hand side in FIG. 3) in which is stored, for each register, the information indicating whether a data word is written into the register.

In the example of view (A), verification table 301 comprises a column Test1(Req) in which is stored, for each register, information concerning the writing of data into the register. More specifically, this information can indicate whether a data word is required in the register and/or whether the writing of a data word into the register is authorized or not.

In the example of view (B), verification table 302 comprises two columns Test1(Req) and Test2(Forbid), in which are stored, for each register, two pieces of information concerning the writing of data into the register. According to a preferred embodiment, the first column Test1(Req) stores information indicating whether or not the writing of a data item is required in the associated register. According to a preferred embodiment, the second column Test2(Forbid) stores information indicating whether the writing of a data item is authorized, or not, in the associated register.

In the example of view (C), verification table 303 comprises three columns Test1(Req), Test2(Forbid), and Test3. According to an example, columns Test1(Req) and Test2(Forbid) are the same as those of verification table 302.

According to a first embodiment, the third column Test3 stores, for each register, information indicating whether a specific data value is expected during the writing. In this case, the value of the data word to be written is compared with the value of the piece of information. According to an example, this information may be either a value, or a masked data item, or a mask, certain bits of which represent the information.

According to a second embodiment, the third column Test3 stores, for each register, information indicating whether a specific data value is forbidden during the writing, such as the null value. In this case, the value of the data word to be written is compared with the value of the piece of information. According to an example, this information could be either a value, or a masked data item, or a mask, certain bits of which represent the information.

According to a third embodiment, the third column Test3 stores, for each register, information indicating an order of priority of a data word to be written into the register.

According to a fourth embodiment, the third column Test3 stores, for each register, information indicating an order of priority of a data word to be written into the register.

According to a fifth embodiment, the third column Test3 stores, for each register, information indicating whether the data word to be written into the register is to be written permanently or temporarily.

According to a sixth embodiment, the third column Test3 stores, for each register, information indicating the number of registers required for the carrying out of an operation, or, for example, indicating, as a function of information of another register, the number of registers required for the implementation of the operation.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A device for protecting a writing of data into at least one register of at least one first electronic circuit, the device storing a first verification table comprising for each of the at least one register:
at least a first piece of information concerning the writing of data into the at least one register; and
at least a second piece of information indicating whether a data item has been written or not into the at least one register.

2. The device of claim 1, wherein the first piece of information indicates whether a data writing is required in the at least one register.

3. The device of claim 1, wherein the first verification table comprises, for each of the at least one register, a third piece of information concerning the writing of data into the at least one register.

4. The device of claim 3, wherein the third piece of information indicates whether a data writing is authorized in the at least one register.

5. The device of claim 1, wherein the first verification table comprises, for each of the at least one register, a fourth piece of information concerning the writing of data into the at least one register.

6. The device of claim 5, wherein the fourth piece of information indicates:
whether a value of the data item to be written is authorized or not;
whether the data item to be written has priority or not; or
whether the data item to be written is temporary or permanent.

7. The device of claim 1, wherein the first verification table is adapted to being used during a data writing comprised in an implementation of a first instruction by a processor.

8. The device of claim 7, wherein the device is further storing a second verification table.

9. The device of claim 8, wherein the second verification table is adapted to being used during a data writing in an implementation of a second instruction by the processor, different from a first instruction.

10. The device of claim 1, further protecting a writing of data into at least one register of at least one second electronic circuit that is different from the first electronic circuit.

11. The device of claim 1, wherein the first circuit is adapted to modify the first verification table.

12. An electronic system comprising the device of claim 1 and a control circuit.

13. A method of protecting a writing of data into at least one register of at least one electronic circuit comprising:
storing, by a protection device, a first verification table comprising for each of the at least one register:
a first piece of information concerning the writing of data into the at least one register; and
a second piece of information indicating whether a data item has been written or not into the at least one register.

14. The method of claim 13, wherein the first piece of information indicates whether a data writing is required in the at least one register.

15. The method of claim 13, wherein the first verification table comprises, for each of the at least one register, a third piece of information concerning the writing of data into the at least one register.

16. The method of claim 15, wherein the third piece of information indicates whether a data writing is authorized in the at least one register.

17. The method of claim 13, wherein the first verification table comprises, for each of the at least one register, a fourth piece of information concerning the writing of data into the at least one register.

18. The method of claim 17, wherein the fourth piece of information indicates:
whether a value of the data item to be written is authorized or not;
whether the data item to be written has priority or not; or
whether the data item to be written is temporary or permanent.

19. The method of claim 13, wherein the first verification table is adapted to being used during a data writing comprised in an implementation of a first instruction by a processor.

20. The method of claim 13, wherein the device further comprises a second verification table.
